(19) United States
(12) Patent Application Publication
(10) Pub. No.: US 2010/0283175 A1
(43) Pub. Date: Nov. 11, 2010

(54) COEXTRUDED POLYMER MOLDING HAVING SELECTIVELY NOTCHED CARRIER

(75) Inventors: Shawn Jyawook, Ann Arbor, MI (US); Jim Browell, Ann Arbor, MI (US); Benoit Singher, Howell, MI (US)

Correspondence Address: BROOKS KUSHMAN P.C., 1000 TOWN CENTER, TWENTY-SECOND FLOOR, SOUTHFIELD, MI, 48075, US

(73) Assignee: JYCO SEALING TECHNOLOGIES, INC., Dexter, MI (US)

(21) Appl. No.: 12/838,055

(22) Filed: Jul. 16, 2010

Related U.S. Application Data
(63) Continuation of application No. 12/055,603, filed on Mar. 26, 2008.

(51) Int. Cl. B29C 47/02

(52) U.S. Cl. 264/138

(57) ABSTRACT

A coextruded polymer molding product includes a notched structural carrier and a polymer seal material over the structural carrier. The structural carrier has notches along its length A first plurality of specific regions of the structural carrier have notches. A second plurality of specific regions of the structural carrier are relieved from having notches. The notched regions and relieved regions are arranged with respect to each other such that consecutive notched regions are spaced apart at non-uniform intervals to provide desired bending characteristics for conforming to a specific molding application.

### BACKGROUND OF THE INVENTION

1. Field of the Invention

The invention relates to coextruded polymer moldings such as weather seals for automotive applications. The invention further relates to coextruded polymer weather seals of the type wherein a core or structural carrier is extrusion molded, and the sealing material is extruded over the structural carrier.

2. Background Art

A modern automobile body includes a number of body openings where weather seals are applied. For example, an automobile door opening requires a weather seal that conforms to the shape of the opening. The seal functions to keep rain and other environment elements out, and may reduce the presence of wind noise inside the vehicle.

Conventionally, rubber weather seals have been used for automotive seal applications. Rubber seals degrade over time, and conventional thermoset rubber cannot be recycled for re-use. Thermoplastic materials have also been used for automotive seal applications. Thermoplastic elastomers may be recyclable.

In one existing approach to making a weather seal, a metallic structural carrier has been used. The sealing material is molded over the metallic carrier. The metal carrier starts out flat or preformed, and after the seal is extruded over the carrier, the carrier is bent as required into the traditional U-shape for subsequent attachment to a vehicle body flange.

Notched structural carriers have been used for some automotive seal applications. As well, in addition to the metal structural carriers, hard synthetic resin materials have also been used as structural carriers.

Although notched structural carriers have been used for certain automotive applications, with the notches allowing the carrier to conform to the specific automotive body opening, the notches result in reduced stiffness and could affect seal retention. As well, the notches may show through the seal material, giving a somewhat wavy appearance (known as hungry horse) due to the underlying skeletal structure of the notched carrier.

Background information may be found in U.S. Pat. No. 7,044,525 and U.S. Pub. No. 2006/0267362. Further background information may be found in U.S. Pub. Nos. 2003/0157316, 2005/0193636, and 2008/0034666. Further background information may be found in UK Patent Application publication GB 2413144 A, and Japanese publication P2002-370272A (the drawings show notched carriers).

### SUMMARY OF THE INVENTION

It is an object of the invention to provide an improved coextruded polymer molding having a selectively notched structural carrier.

The invention comprehends a coextruded polymer molding, such as a weather seal for automotive body opening applications, which includes a structural carrier that is selectively notched and relieved in specific regions along its length. The selective notching allows the bending characteristic of the final extruded product to be tuned to more precisely conform to a desired radius and bending axis of a specific automotive body opening application.

In accordance with the invention, notches or serrations of the structural carrier are only required where needed. In this way, where the weather seal must bend to follow, for example, a curved portion of an automotive vehicle body opening, the notches allow conformance. At the same time, straight sections of the weather seal are relieved from having notches to eliminate the wavy appearance (hungry horse) that normally would be present due to an underlying notched carrier. It is to be appreciated that, in addition to eliminating the wavy appearance in the straight sections of the weather seal, seal retention is improved in these areas due to increased beam-like stiffness of the un-notched regions.

### BRIEF DESCRIPTION OF THE DRAWINGS

FIG. 1 is a perspective view of a coextruded polymer weather seal made in accordance with an exemplary embodiment of the invention;

FIGS. 2A-2I illustrate various structural carrier profiles and notching schemes which may be used for coextruded polymer moldings made in accordance with the invention;

FIG. 3A is an exemplary selectively notched structural carrier for a weather seal constructed to fit a typical automobile door opening;

FIGS. 3B-3G illustrate various enlarged views showing portions of the structural carrier shown in FIG. 3A;

FIG. 4 illustrates a process of manufacturing coextruded polymer moldings in accordance with the invention;

FIG. 5A is an exemplary coextruded polymer weather seal constructed to fit an automobile storage-area opening;

FIGS. 5B-5C illustrate enlarged views showing portions of the structural carrier for the weather seal shown in FIG. 5A; and

FIG. 6 illustrates an example carrier wherein the carrier is broken locally at a curve to add flexibility.

### DETAILED DESCRIPTION OF THE PREFERRED EMBODIMENT

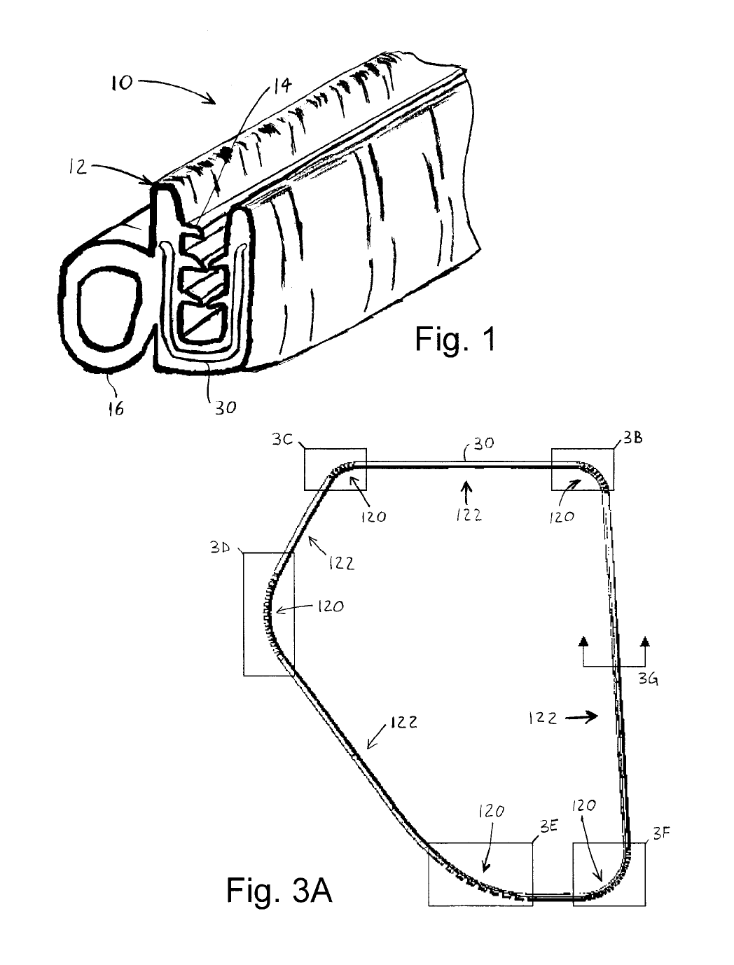

FIG. 1 illustrates an exemplary coextruded polymer weather seal made in accordance with the invention. The weather seal is generally indicated at 10, and includes a main body 12 made of a polymer seal material. Body 12 is adapted for mounting on a corresponding vehicle body structure. Retaining grippers 14 are formed as part of the main body 12. A sealing portion 16 is provided for sealing an interface between adjacent vehicle body structures. A structural carrier 30 is made of a polymer core material. In general, the structural carrier is extrusion molded, and the sealing material is extruded over the carrier 30. Further, prior to extruding the sealing material over the carrier 30, a notching pattern is cut into the carrier.

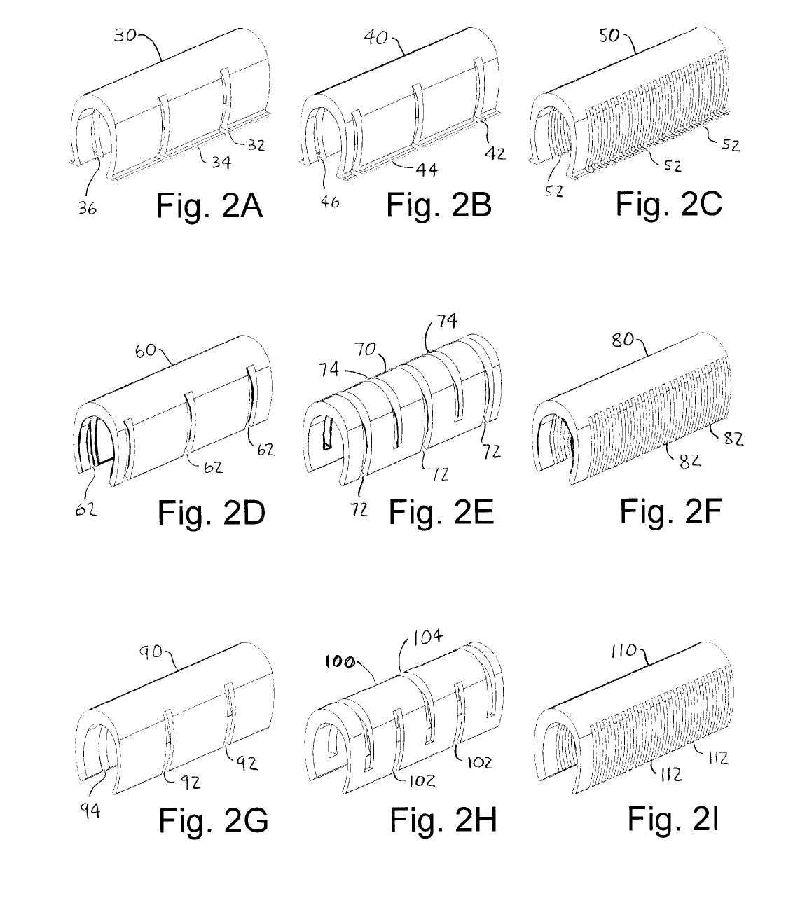

As best shown in FIGS. 2A-2I, various carrier profiles and notching schemes may be employed. FIG. 2A illustrates structural carrier 30 having a profile including a flange portion 34, and opposed notches 32 and 36. The notches 32 on one side of the carrier 30 are staggered from the notches 36 on the other side of the carrier 30. The notches allow the bending characteristics of the final extruded product to be tuned to more precisely conform to a desired radius and bending axis of a vehicle body opening application.

In FIG. 2B, structural carrier 40 includes a flange portion 44. Carrier 40 further includes notches 42 on one side of carrier 40 that are aligned with notches 46 on the other side of carrier 40. FIG. 2C shows a different approach for the carrier, wherein the structural carrier 50 includes thin and closely spaced notches 52 along each side of carrier 50.

FIGS. 2D-2F illustrate additional exemplary carrier profiles. As shown in FIG. 2D, carrier 60 includes a sequence of notches 62 on each side. As shown in FIG. 2E, carrier 70 includes notches 72 and notches 74. In this example, the notches extend from the bottom of one side of the carrier, around the top and partially down the other side of the carrier. FIG. 2F illustrates a carrier profile similar to that shown in FIG. 2C; carrier structure 80 includes thin and closely spaced notches 82 along each side of carrier 80.

Additional example carrier structures are shown in FIGS. 2G-2I. In more detail, FIG. 2G depicts carrier 90 including a sequence of notches 92 on one side of the carrier 90, and a sequence of notches 94 on the other side of the carrier 90. The notches on one side are staggered with respect to the notches on the other side of carrier 90. As shown in FIG. 2H, carrier 100 includes notches 102 and notches 104. In this example, the notches extend up from the bottom (notches 102) or down from the top (notches 104) of the carrier 100. FIG. 21 illustrates a carrier structure 110 including thin and closely spaced notches 112 along each side of carrier 110.

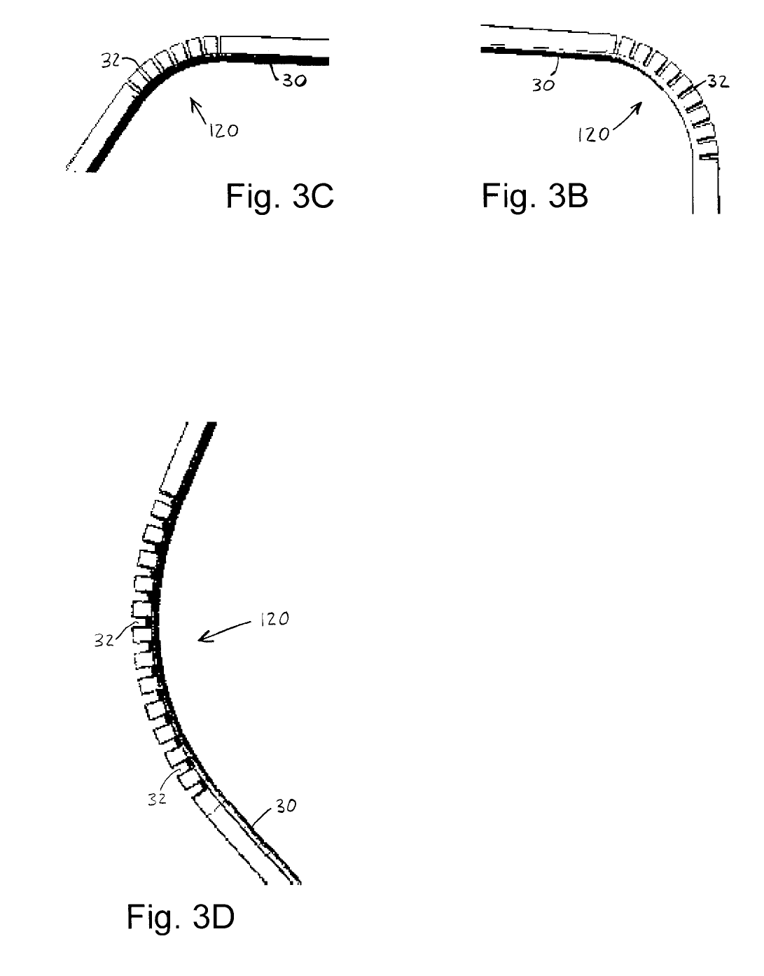

FIG. 3A illustrates an exemplary selectively notched structural carrier 30 for a weather seal constructed to fit a typical automobile door opening, and FIGS. 3B-3G illustrate various enlarged views showing portions of the carrier 30. In accordance with the invention, a desired notching pattern for notching the structural carrier 30 along its length is determined such that the bending characteristics for the final extruded product conform to a specific molding application, in this case, a weather seal for an automotive door.

Carrier 30 includes a plurality of notched regions 120 and a plurality of regions 122 that are relieved from having notches. As shown, the notched regions 120 and relieved regions 122 are arranged with respect to each other in accordance with the specific molding application. The enlarged views show in FIGS. 3B-3G correspond to, in FIG. 3A, the boxes marked 3B-3F and line 3G indicating the cross-section shown in FIG. 3G.

In each of FIGS. 3B-3F, the notched region of the carrier is generally indicated at 120, and the region includes notches 32. In FIG. 3A, the notched regions 120 and relieved regions 122 are spaced apart at non-uniform intervals to conform to the door opening.

The selective notching tunes a notched region 120 to conform to the radius and bending axis of the corresponding curve in the vehicle body opening. For example, notches 32 shown in FIGS. 3B-3F facilitate fitting the molding to the radius of each curve in the door opening. Further, by only providing notches 32 at the bends, the straight sections 122 of the carrier 30 avoid the wavy appearance (hungry horse) in the final product, and improve retention in the straight sections 122.

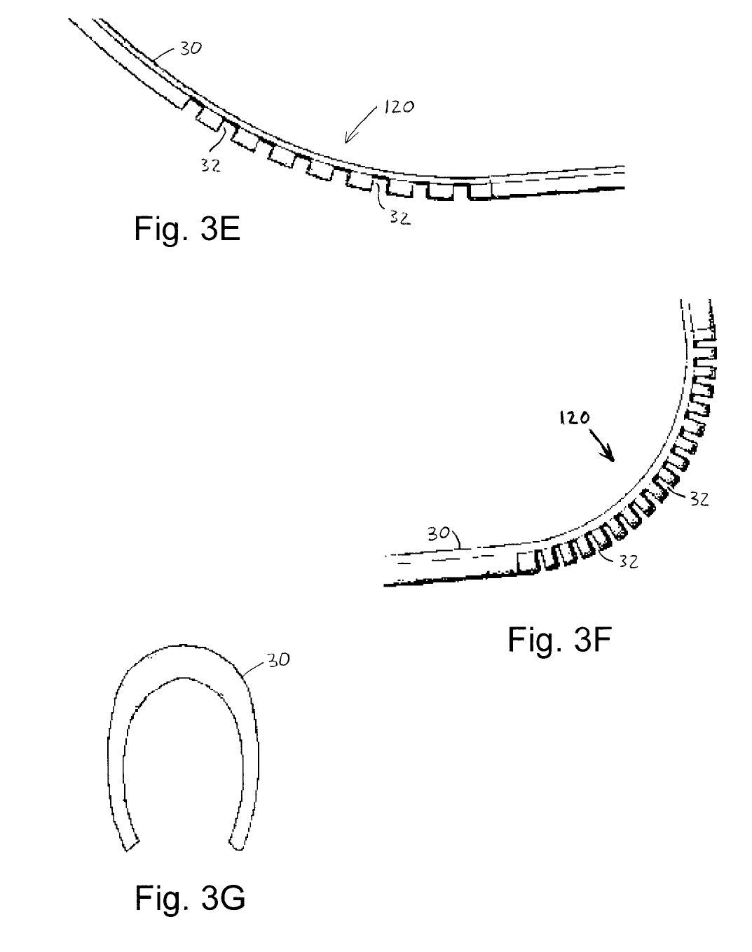

FIG. 4 illustrates a process of manufacturing a coextruded polymer molding. The polymer core material is extruded in a first die 132 by extruder 130 to form a structural carrier 136 having a U-shaped cross-section (for example, as shown in FIG. 1 and FIG. 3G). Other cross-sections (for example, V-, J-, or C-shaped) for the carrier could be used in the alternative to reinforce gripping of the molding product to the flange. Cooler 134 cools the material and the material is advanced to notching station 140. Notching station 140 notches the carrier in accordance with the desired notching pattern. In accordance with the invention, the desired notching pattern includes a plurality of specific regions having notches and a plurality of specific regions relieved or void of notches. The notched regions and relieved regions are arranged with respect to each other such that consecutive notched regions are spaced apart at non-uniform intervals such as shown in FIG. 2A. In this way, the notching pattern allows the structural carrier and the final molding product to confirm to the requirements of a specific application.

After notching at notching station 140, the notched carrier is advanced through die 152 and extruder 150 extrudes a polymer sealing material over the carrier to form the final molding product. The final product is cooled at cooler 154, and subsequently cut to required length. The notched carrier may be advanced from notching station 140 on the carrier extrusion line directly to the main extrusion line, or may go to coiling unit 156 and then, subsequently, to the main extrusion line.

It is appreciated that the coextruded molding products may be made from a variety of materials. In the preferred embodiment, the structural carrier is made of a thermoplastic olefin (TPO). Materials other than TPO could be used in the alternative. The sealing portion is preferably made of a thermoplastic vulcanizate (TPV). Materials other than TPV could be used in the alternative. In the preferred embodiment, the structural carrier and the elastic sealing material are chemically similar, and the process scrap can be ground up and reintroduced into the extrusion process.

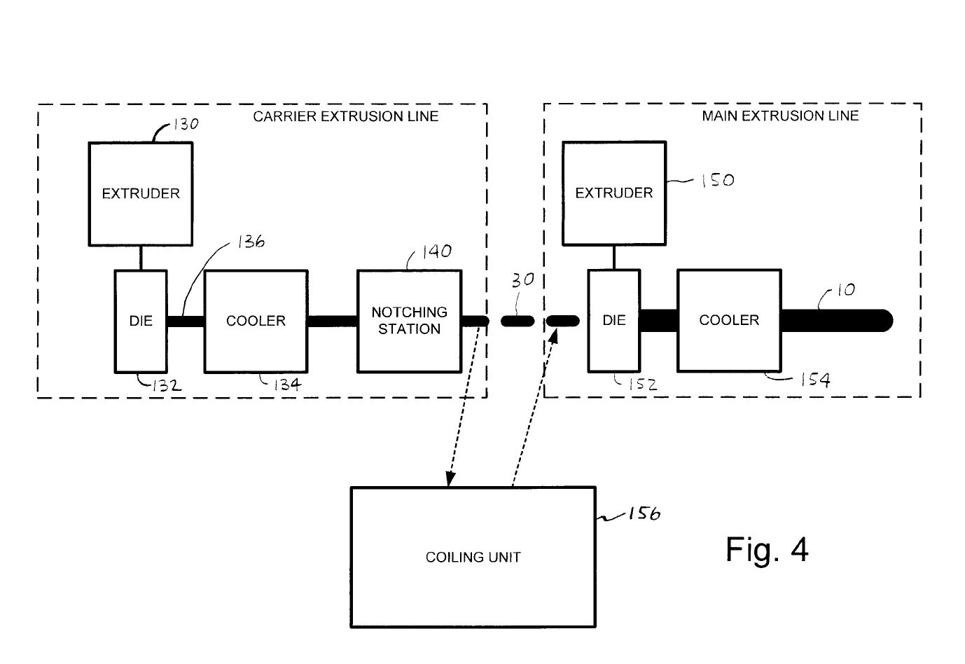

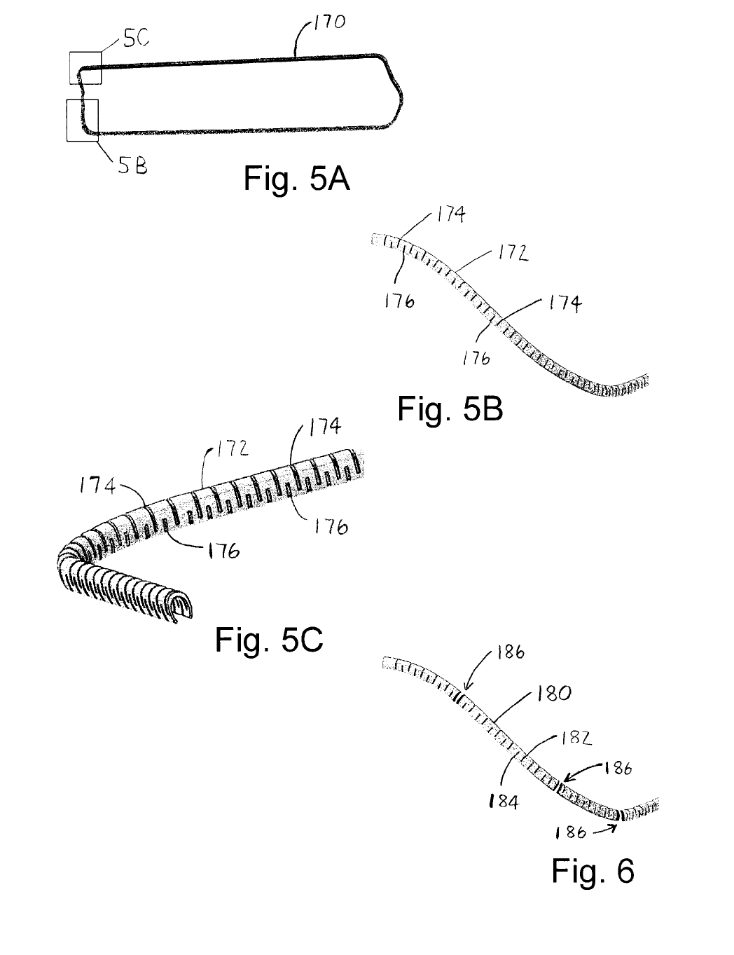

It is appreciated that embodiments of the invention also include coextruded molding products including compound curves. FIG. 5A illustrates an exemplary weather seal 170 constructed to fit an automobile storage-area opening. Weather seal 170 includes a “waterfall” portion at the box marked 5B where the carrier curves in three dimensions. FIG. 5B corresponds to the box 5B, and shows the carrier 172. In FIG. 5A, the box marked 5C corresponds to FIG. 5C where the portion of carrier 172 for a corner of weather seal 170 is illustrated. This example structural carrier 172 includes notches 174 extending downward from the top of the carrier 172 and notches 176 extending upward from the bottom of carrier 172. FIG. 5B illustrates the “waterfall” with the notch pattern allowing carrier 172 to curve both downward and sideways. In accordance with the invention, carrier structures may take a variety of forms in addition to the examples illustrated herein depending on the particular application for the final molding product. Other modifications may also be made as needed for a particular application. For example, the carrier may be broken locally in a radius area to add flexibility where needed. That is, the final extruded product with the sealing material molded over the carrier may have the plastic carrier broken locally in a particular area with a sharp curve. FIG. 6 illustrates a carrier “waterfall” portion 180, having notches 182 and 184, and further having a series of breaks 186 over a length of carrier 180 to add further flexibility to the carrier 180. Preferably, the sealing material, omitted in FIG. 6 to show the carrier, remains unbroken.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method of making a coextruded polymer molding product, the method comprising:
extruding a polymer core material to form a structural carrier;
determining a desired notching pattern for notching the structural carrier along its length to form a notched structural carrier wherein a first plurality of specific regions have notches, wherein a second plurality of specific regions are relieved from having notches, each notched region including multiple notches, and wherein the notched regions and relieved regions are arranged with respect to each other based on desired bending characteristics for a final coextruded product such that the final coextruded product conforms to a specific molding application;
selectively notching the structural carrier in accordance with the desired notching pattern; and
extruding a polymer seal material over the notched structural carrier to form the coextruded product.

2. The method of claim 1 wherein the specific molding application is an automotive body opening application, and wherein determining the desired notching pattern further comprises:
determining the desired notching pattern such that the notched regions correspond to curved sections of the final coextruded product when the final coextruded product is attached at the automotive body opening.

3. The method of claim 1 wherein the specific molding application is an automotive body opening application, and wherein determining the desired notching pattern further comprises:
determining the desired notching pattern such that the relieved regions correspond to straight sections of the final coextruded product when the final coextruded product is attached at the automotive body opening.

4. The method of claim 1 wherein the specific molding application is an automotive body opening application, and wherein determining the desired notching pattern further comprises:
determining the desired notching pattern such that the notched regions correspond to curved sections of the final coextruded product when the final coextruded product is attached at the automotive body opening, wherein a particular notched region has a local notch pattern based on bending characteristics of a corresponding particular curved section of the final coextruded product.

5. The method of claim 4 wherein the final coextruded product is a weather seal.

6. The method of claim 1 wherein the final coextruded product is a weather seal.

7. The method of claim 1 wherein the polymer core material comprises a thermoplastic material.

8. The method of claim 1 wherein the polymer seal material comprises a thermoplastic material.

9. The method of claim 8 wherein the polymer seal material comprises a thermoplastic vulcanizate (TPV).

10-22. (canceled)
